(19) United States
(12) Patent Application Publication
(10) Pub. No.: US 2016/0360921 A1
(43) Pub. Date: Dec. 15, 2016

(54) Hands-Free Automatic Food Stirring Appliance

(71) Applicant: Shahzad Sarwar, Tomball, TX (US)

(72) Inventor: Shahzad Sarwar, Tomball, TX (US)

(21) Appl. No.: 14/738,965

(22) Filed: Jun. 15, 2015

(51) Int. Cl. A47J 36/32; B01F 15/06; A47J 43/07

(52) U.S. Cl. CPC A47J 36/32; A47J 43/07; B01F 15/06; B01F 2015/062; B01F 2215/0014

(57) ABSTRACT

The invention provides an improved automatic spinner for food items which may be utilized for unattended stirring of foods during cooking using self-contained electrical power while performing in various timed modes. The automatic stirrer with spinners of the invention is capable of going in clockwise and anti-clockwise directions. The spinner attached with a bearing rod for placing in the cooking utensil. The automatic stirrer is optionally connected to the timer for timed stirring of the foods where the timer is a digital timer. The invention also provides a spinner attached with a bearing rod, a pan gripper attached therewith for placing in the cooking utensil further connected to the timer for timed stirring of the foods.

### CROSS REFERENCE TO RELATED APPLICATIONS

Not applicable.

### FEDERALLY SPONSORED RESEARCH AND DEVELOPMENT

Not applicable.

### MICROFICHE

Not applicable

### BACKGROUND OF THE INVENTION

(1) Field of the Invention

The present invention relates to cooking accessory and, more particularly, to a motorized self-spinning tool for food within a container. This invention relates to a food preparation appliance, and in particular to a portable, battery-operated food spinner with timer that is adapted to be used on a variety of different sized cooking vessels. The food spinner is an appliance with a housing containing a rechargeable battery.

(2) Background

The prior art reveals a wide variety of automatic cooking devices, including, for example, devices which automatically cook bread, rice, soups, and popcorn, with little effort required of the user other than placing the Ingredients within the device and turning it on. Automatic cooking devices allow the user to reap the health and flavor benefits of home-cooked food without having to invest a high amount of time or effort into the preparation of such food.

In today's increasingly health conscious society, people want to incorporate healthier meals, such as meat and vegetable stir-fry meals, into their diets. The problem that these people face is dedicating the time to cooking a healthy meal. There is a plenitude of pre-packaged frozen vegetables and pre-cut meats that can be used to create meals, but the user must still dedicate the time to standing over the stove and cooking the food.

One challenge for an automatic cooking device is stirring the food effectively enough so that it gets thoroughly cooked. In some cookers the food never gets turned over. The food cooks on one side only and can end up being burned on the side in contact with the pan surface while the other side is still raw.

For example, recipes typically require food to be transferred to and from a cooking container during the heating process. In order to transfer food using common utensils (e.g., a measuring cup, a ladle, tongs, etc.), without splattering food on a work surface or on the cook, it is important that the utensil easily fit within the opening of the container. Optimally, both the utensil and a portion of a user's hand should fit within the container opening to allow a controlled transfer of the food.

The food spinner or stirrer of this invention is designed for use in the home, a restaurant, or a commercial cooking establishment for stirring sauces, broths, gravies, confections, and other temperature sensitive food preparations that customarily must be diligently monitored to prevent scorching or excessive thickening. Although the food stirring appliance of this invention may be an item of convenience for use in the home, in a restaurant kitchen or a commercial cooking establishment, the food stirrer can be an economic necessity. In the restaurant kitchen the concurrent preparation of the many different dishes and courses that go into a meal for many different diners creates a scheduling nightmare. The kitchen chef is unable to continually monitor the preparation of sauces and gravies that are being prepared. While an over-thickened sauce or gravy may be salvaged by thinning, if the sauce or gravy has been scorched, the taste is destroyed and the sauce must be discarded. Similarly, in the commercial cooking environment, often large vats or pots are used to prepare larger volumes of ingredients for prepared commercial foods. In such situations, the burning of an Ingredient such as a confectionery topping could cause an interruption in the production and serious delay in the scheduling of other steps in the processing.

Current self-stirring cooking devices include stirring hardware mounted in a lid or on a legged bridge that extends over the container opening, between two or more portions of the container's rim. This arrangement is inconvenient when trying to transfer food, because a bridge, or lid, of the stirring device covers large portions of the container opening, thus reducing the available space within which to fit a utensil and/or hand. Quite often, the user must stop the stirring device, remove the stirring hardware from the container opening, transfer the ingredients, reposition the stirring hardware, and finally restart the stirring device.

A second disadvantage seen in current self-stirring devices is poor positioning of the stirring blade. The food next to the bottom inner surface of the container is closest to the heating source and should be frequently moved to prevent the food from burning and sticking to the container. In order to move the bottom layer of food, it is very important to position the stirring blade close to the bottom inner surface of a food container. Many current stirring devices have blades positioned relatively far above the bottom inner surface of the container. This causes a layer of food to remain unstirred on the bottom of the container. Eventually, the food will overheat and burn, giving the remaining food a burned taste. Even a relatively small layer of unstirred food can produce enough burned material to destroy the taste of a dish.

Poor blade positioning also occurs when the vertical shaft of a stirring device and/or blades mounted on the lower end of the vertical shaft are bent or distorted. In this regard, the lower end of the blades of most stirring devices is unsupported. In watery foods, the reactive force applied to a blade mounted on a vertical shaft whose lower end is unsupported during mixing is usually inadequate to bend or distort the shaft or the blade. In contrast, the reactive force applied to a blade mounted on a vertical shaft whose lower end is unsupported when mixing rigid ingredients such as unmelted cheese or butter, can bend and distort the shaft and/or the blade. This often occurs when blades become stalled when trying to push a clump of food forward. A bent vertical shaft is undesirable because it may cause the shaft or the blade to scrape or scratch the inner surface of a container. Poorly mixed food may also result, as well as damage to the motor assembly if the vertical shaft stalls for an extended period of time.

The known prior art discloses a manual mixer that has a cone-shaped projection on the bottom inner surface of a container about which the vertical shaft and blade is rotated. The projection helps to keep the vertical shaft from moving laterally away from its optimum position, and thus acts as a lateral support for the blade and vertical shaft. The projection, however, does not prohibit the vertical shaft from moving vertically upward during spinning. Upward movement of the vertical shaft of a stirring device results in a corresponding upward movement of blades attached to the vertical shaft, resulting in the formation of an unstirred food layer to undesirably remain on the bottom inner surface of the container. Therefore, for stirring devices used in heating food, known till date are not adequately solving the problem of poor blade and/or vertical shaft positioning.

Thus, a need exists for a new and improved self-stirring cooking device that allows the user to easily add or remove ingredients from the container using common household utensils. The ideal self-stirring cooking device should have a blade that is kept at a very close distance to the bottom of the container during all types of stirring. As a part of basic design principles, the ideal device should protect its motor assembly from damage should a vertical shaft or a blade become stalled. The ideal device should also protect the user from electrical shock in the event the device becomes immersed into conductive foods. Lastly, as with any household appliance, the entire device should be easy to assemble and disassemble, easy to clean and easy to store.

While the prior art units may be suitable for the particular purpose employed, or for general use, they would not be as suitable for the purposes of the present invention as disclosed hereafter.

It is thus an objective of the present invention to overcome the disadvantages of the prior art and in particular to provide an automatic spinners for food items which may be utilized for unattended stirring of foods during cooking using self-contained electrical power while performing in various timed modes.

The present invention, overcomes the discussed problems by providing an improved an automatic stirrer for food items which may be utilized for unattended stirring of foods during cooking using self-contained electrical power while performing in various timed modes. Another important advantage of the present invention is that the stirrer is embodied with a bearing rod with pan gripper to hold the cooking utensil stable while cook, stir or rotate the food present therein.

As such, it may be appreciated that there continues to be a need for a new and improved automatic stirrer for food items which may be utilized for unattended stirring of foods during cooking, the present invention substantially fulfills this need.

### SUMMARY OF THE INVENTION

Directed to fulfilling these needs, the present invention includes an automatic stirrer for food items which may be utilized for unattended stirring of foods during cooking. In view of the foregoing disadvantages inherent in the known types of automated stirrers for foods, now present in the prior art, the present invention provides an improved stirrer for food items with timer to manage the stirring at a pre-set time while cooking. As such, the general purpose of the present invention, which will be described subsequently in greater detail, is to provide a new and improved automated stirrers for foods which has all the advantages of the prior art of disposable built-in beverage cup lid and none of the disadvantages.

The object of the present invention is to provide an automatic spinners for food items which, by virtue of its design and components, satisfies some of the above-mentioned needs and is thus an improvement over other related systems and/or methods known in the prior art.

A primary object of the present invention is to provide an improved automatic spinners for food items which may be utilized for unattended stirring of foods during cooking using self-contained electrical power while performing in various timed modes.

It is therefore an object of the present invention to provide an improved automatic stirrer with spinners capable of going in clockwise and anti-clockwise directions.

It is a further object of the present invention to provide an improved automatic stirrer including a spinner attached with a bearing rod for placing in the cooking utensil.

It is therefore an object of the present invention to provide an improved automatic stirrer attached with a bearing rod and a pan gripper provided therewith for holding the cooking utensil stable while stirring.

It is therefore an object of the present invention to provide an improved automatic stirrer including a spinner attached with a bearing rod, a pan gripper attached therewith for placing in the cooking utensil further connected to the timer for timed stirring of the foods.

It is therefore an object of the present invention to provide an improved automatic stirrer connected to the timer for timed stirring of the foods where the timer is a digital timer.

It is therefore an object of the present invention to provide an improved automatic stirrer connected to the timer for timed stirring of the foods where the timer is a digital timer is embodied with the features like alarm, speed indicator, internal switch, LED green and red lights to indicate the appliance is in use.

It is another object of the present invention to provide an improved automatic spinners for food items which may be utilized for unattended stirring of foods during cooking using self-contained electrical power which can be provided through a rechargeable batteries or power cord.

Preferably, the improved automatic spinners for food items which may be utilized for unattended stirring of foods during cooking and avoid food burn and result in perfect cooking.

Other aspects of the present invention will become apparent from time to time throughout the specification as hereinafter related.

There has thus been outlined, rather broadly, the more important features of the invention in order that the detailed description thereof that follows may be better understood, and in order that the present contribution to the art may be better appreciated.

It is noted the purpose of the foregoing summarized matter is to enable the Patent Office and the public generally, especially the scientists, engineers and practitioners in the art who are not familiar with patent or legal terms or phraseology, to determine quickly from a cursory inspection the nature and essence of the technical disclosure of the application.

These together with other objects of the Invention, along with the various features of novelty which characterize the invention, are pointed out with particularity in the disclosure. For a better understanding of the invention, its operating advantages and the specific objects attained by its uses, reference should be had to the descriptive matter in which there are illustrated preferred embodiments of the invention.

### BRIEF DESCRIPTION OF THE DRAWINGS

To further clarify various aspects of some example embodiments of the present invention, a more particular description of the invention will be rendered by reference to specific embodiments thereof which are illustrated in the appended drawing. It is appreciated that the drawing depicts only illustrated embodiments of the invention and are therefore not to be considered limiting of its scope. The invention will be described and explained with additional specificity and detail through the use of the accompanying drawing in which:

FIG. 1 depicts perspective views of the spinner, pan gripper and bearing rod according to a preferred embodiment of the current invention.

FIG. 2 depicts a perspective view of the improved automatic spinning tool according to a preferred embodiment of the current invention.

### DETAILED DESCRIPTIONS OF THE INVENTION

In the following description, the same numerical references refer to similar elements. The embodiments, dimensions, components and/or geometrical configurations are preferred, for exemplification purposes only.

Before explaining at least one embodiment of the invention in detail, it is to be understood that the invention is not limited in its application to the details of construction and the arrangements of the components set forth in the following description. The invention is capable of other embodiments and of being practiced and carried out in various ways. Also, it is to be understood that the phraseology and terminology employed herein are for the purpose of description and should not be regarded as limiting.

In a preferred embodiment, the invention provides an improved automatic spinner for food items which may be utilized for unattended stirring of foods during cooking using self-contained electrical power while performing in various timed modes. The automatic stirrer with spinners of the invention is capable of going in clockwise and anti-clockwise directions. The spinner attached with a bearing rod for placing in the cooking utensil. The automatic stirrer is optionally connected to the timer for timed stirring of the foods where the timer is a digital timer.

In still yet another preferred embodiment of the invention provides an improved automatic stirrer attached with a bearing rod and a pan gripper provided therewith for holding the cooking utensil stable while stirring.

In still yet another preferred embodiment of the invention provides an improved automatic stirrer connected to the timer for timed stirring of the foods where the timer is a digital timer embodied with features like alarm, a speed indicator, an internal switch, LED green and red lights to indicate the appliance is in use.

In still yet another preferred embodiment of the invention provides an improved automatic spinner for food items which may be utilized for unattended stirring of foods during cooking using self-contained electrical power which can be provided through a rechargeable batteries or power cord.

Preferably, the improved automatic spinners for food items which may be utilized for unattended stirring of foods during cooking and avoid food burn and result in perfect cooking.

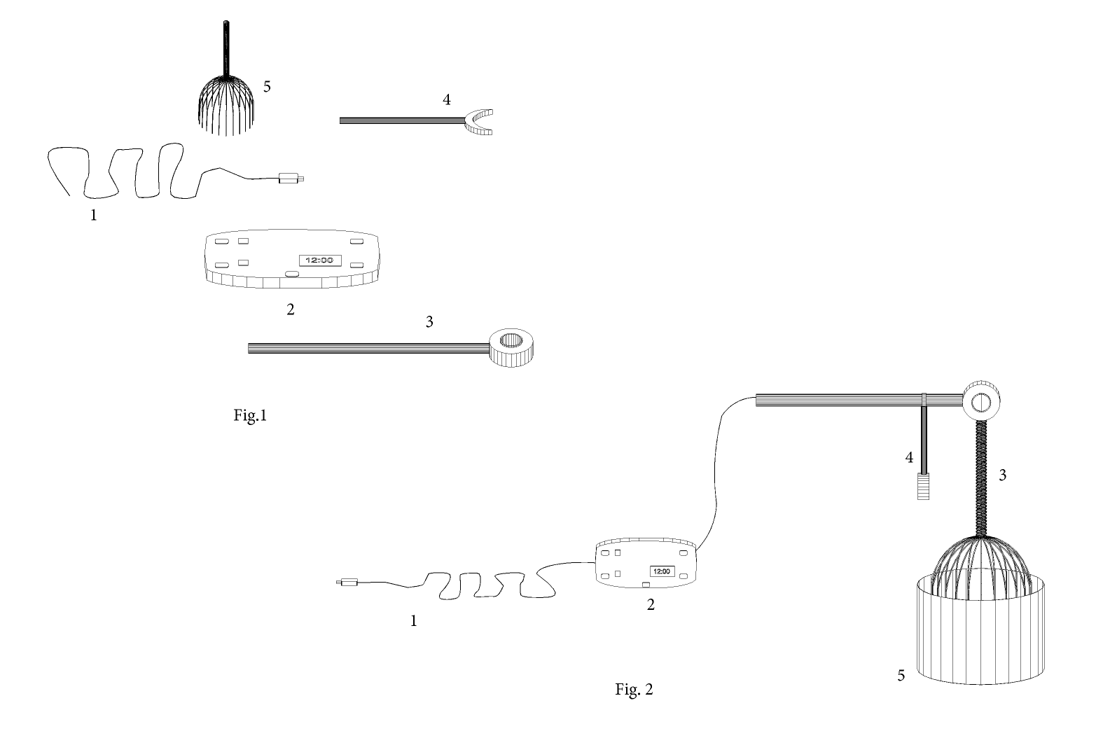

Referring now to the FIGS. 1 and 2, illustrates perspective view of the improved automatic spinning tool according to a preferred embodiment of the current invention. The figure clearly shows that the power cord 1 is connected to the power source and further the tool or appliance consists of a digital timer 2. This digital timer is equipped with the feature of time adjustment feature. Going further the timer is then connected to a bearing rod 3 with two attached branches, namely pan gripper 4 and spinner attachment 5. The pan gripper is meant to hold the utensil or pan stationary while the spinning tool/stirrer is in switch on mode.

The bearing rod as illustrated is used to hold the attachments of the automated spinner according to the current invention. The pan gripper can be adjusted to hold on various utensils of different sizes. The pan gripper ensures that the utensil in which the stirring or rotating takes place is held stationary during the process. Also illustrated is the spinner attachment of the invention, which is capable of rotating or spinning in either direction i.e. clockwise or anticlockwise both.

The timer used herein is a digital timer capable of being adjusted by the user to decide the time for which the spinning is to be carried out. An alarm is provided with the timer to alert the user that the process has been completed. There are small red and green LED lights. The main function of green LED is to inform about the appliance is plug-in but not in use and the red light indicated that the appliance is in use.

It is to be understood that the above description is intended to be illustrative, and not restrictive. For example, the above-discussed embodiments may be used in combination with each other. Many other embodiments will be apparent to those of skill in the art upon reviewing the above description.

The benefits and advantages which may be provided by the present invention have been described above with regard to specific embodiments. These benefits and advantages, and any elements or limitations that may cause them to occur or to become more pronounced are not to be construed as critical, required, or essential features of any or all of the embodiments.

Therefore, the foregoing is considered as illustrative only of the principles of the invention. Further, since numerous modifications and changes will readily occur to those skilled in the art, it is not desired to limit the invention to the exact construction and operation shown and described, and accordingly, all suitable modifications and equivalents may be resorted to, falling within the scope of the invention.

I claim:

1. An automatic spinner apparatus for unattended automatic stirring comprising:
spinner;
a self-contained electrical power means performing in various timed modes;
a bearing rod for placing in the cooking utensil;
a pan gripper for holding the cooking utensil stable while stirring; and
a timer.

2. The automatic spinner apparatus of claim 1 wherein said timer further comprising:
an alarm;
a speed indicator;
an internal switch; and
LED green and red lights indicating the use of said spinners.

3. The automatic spinner apparatus of claim 1 wherein said timer is a digital timer.

4. The automatic spinner apparatus of claim 1 wherein said spinner turning in clockwise and anti-clockwise directions.

5. The automatic spinner apparatus of claim 1 wherein said spinner are attached with said rod.

6. The automatic spinner apparatus of claim 1 wherein said spinner is attached with a pan gripper for holding the cooking utensil stable while stirring.

7. The automatic spinner apparatus of claim 1 wherein said spinner connected to said timer for timed stirring of the foods.

8. The automatic spinner apparatus of claim 1 wherein said spinner is attached with said timer wherein said timer is a digital timer is embodied with the features like alarm, speed indicator, internal switch, LED green and red lights to indicate the appliance is in use.

9. The automatic spinner apparatus of claim 1 wherein said self-contained electrical power means is a rechargeable batteries.

10. The automatic spinner apparatus of claim 1 wherein said apparatus connected to self-contained electrical power means by a power cord
